(19) United States
(12) Patent Application Publication
(10) Pub. No.: US 2006/0147891 A1
(43) Pub. Date: Jul. 6, 2006

(54) Education management system including lesson plan file compilation

(76) Inventors: Ricardo Dreyfous, Guaynabo, PR (US); Reinaldo Ortiz, Augusta, GA (US)

Correspondence Address: NIXON & VANDERHYE, PC, 901 NORTH GLEBE ROAD, 11TH FLOOR, ARLINGTON, VA, 22203, US

(21) Appl. No.: 11/303,032

(22) Filed: Dec. 16, 2005

Related U.S. Application Data
(60) Provisional application No. 60/636,315, filed on Dec. 16, 2004.

(51) Int. Cl. G09B 7/00

(52) U.S. Cl. 434/362

(57) ABSTRACT

A classroom network management system includes a server computer running a manager program, and a plurality of client computers each running a student desktop program and having controllable access to computerized resources. The server computer and the plurality of client computers are interconnected by a network. The manager program administers communications between the server computer and the client computers and communications among the client computers, and the manager program controls access by the client computers to the computerized resources. The manager program includes a lesson builder tool that selectively stores lesson content for presentation on the client computers via the server computer. In this context, the lesson content includes a lesson plan, at least one file of a word processing application, spreadsheet application, presentation tools or multimedia, exercises for student review, and evaluations for student testing.

### CROSS-REFERENCES TO RELATED APPLICATIONS

This application claims the benefit of U.S. Provisional Patent Application Serial No. 60/636,315, filed Dec. 16, 2004, the entire content of which is herein incorporated by reference.

### BACKGROUND AND SUMMARY OF THE INVENTION

Conventional teaching methods utilize books or other copy material as teaching and learning sources. Teachers play an important role in explaining the information contained in the materials. Learning via books and lectures alone, however, can become tedious to students, and it becomes the teacher's responsibility to maintain the students' attention and enable the students to absorb the lessons in an effective manner. Technology has become increasingly more important in the educational environment. Teachers need tools to individualized, to help them use technology without the negative elements attached to it, ways to distribute their educational materials in a technology environment and ways to evaluate their students when using technology. Teachers do not have the time to learn a new software every day and teachers from different subject matter need to have the same platform to work on either On-line or Off-line.

The system of the invention utilizes a computerized network interconnecting the teacher's computer and a plurality of student desktop. The system is designed to administrate a class via the network and enable the teacher to maintain control of computerized resources in the classroom. The system allows a teacher to input a lesson and authorize access levels/permissions to each student desktop/computer individually. Access levels are entirely defined by the teacher and can include everything from teacher inputs only to unlimited Internet access.

The teacher determines when it is appropriate for the students to have access to their computer desktop and which of the resources will be available to them. In this manner, all of the students can work at their own pace. This access is entirely under teacher control. Additionally, the teacher is able to view the work of each student independently.

The system serves to enhance the classroom atmosphere and make for a more effective learning environment.

In an exemplary embodiment of the invention, a classroom network management system includes a teacher's computer running a manager program, and a plurality of client computers each running a student desktop program and having controllable access to computerized resources. The server computer and the plurality of client computers are interconnected by a network. The manager program administers communications between the server computer and the client computers and communications among the client computers, and the manager program controls access by the client computers to the computerized resources. The manager program includes a lesson builder tool that selectively stores lesson content for presentation on the client computers via the server computer. In this context, the lesson content includes at least one of a word processing applications file, spreadsheet applications file and presentation tools and multimedia files; exercises for student review; and evaluations for student testing.

The lesson builder tool enables access via the server computer to create, add, edit and delete lessons (educational content). Each lesson has three parts: Lesson Plan, Content and Evaluation. The lesson plan includes a lesson base including preferred fields as Title, Course, Author, and Objectives, and optional fields as Strategy, Activities, Standard, and Evaluation. The lesson builder tool may enable a selection of evaluation type via the server computer between multiple choice, true or false, open questions and matching. In this context, the lesson builder tool enables entry of correct answers for evaluation types multiple choice, matching and true or false, and the manager program monitors evaluation results via the server computer based on the correct answers.

In another exemplary embodiment of the invention, a classroom network management system includes a plurality of student computer desktop having controllable access to computerized resources. A manager system is interconnected with the student computer desktop via a network. The manager system administers communications between a teacher and the student computer and communications among the student desktop. The manager system controls access by the student computer desktop to the computerized resources. The manager system includes a lesson module that distributes a lesson plan for presentation on the student computer desktop, a screen sharing module that displays a screen view of the manager system to selected ones of the student computer desktop, a screen view of selected ones of the student computer desktop to the manager system, and a screen view of selected ones of the student computer desktop to others of the student computer desktop, and a monitoring module that displays all of the student computer desktop screen views to the manager system.

In one arrangement, the lesson module stores the lesson plan including at least one of word processing applications file, spreadsheet applications files and presentation tools and multimedia files; exercises for student review; and evaluations for student testing. The lesson module preferably enables access via the manager system to create, add, edit and delete lesson content.

### BRIEF DESCRIPTION OF THE DRAWINGS

These and other aspects and advantages of the present invention will be described in detail with reference to the accompanying drawings, in which:

FIG. 1 shows a toolbar for the EMNet Manager application;

FIG. 2 is a screen shot showing the student monitoring feature;

FIG. 2A is a screen shot showing an additional option within the student monitoring feature;

FIG. 3 is a screen shot showing where the teacher selects addresses of the Internet pages made accessible to the students;

FIG. 4 is a screen shot showing a lesson plan created by a teacher;

FIG. 5 is a screen shot from the lesson builder where files are added to the lesson plan;

FIG. 6 is a screen shot showing lesson content as files are added to a lesson plan;

FIG. 7 is a screen shot showing the system creating an EMNet evaluation or test;

FIG. 8 is a screen shot showing the system inputting answers to an evaluation;

FIG. 9 is a screen shot of the Student Desktop, the Disable Task Manager option;

FIG. 10 is a screen shot of the Student Desktop, the Screen Sharing option;

FIG. 11 is a screen shot of the Student Desktop, the Network Settings option; and

FIGS. 12A-12D are screen shots of the Roll Book.

### DETAILED DESCRIPTION OF THE INVENTION

The Educational Manager for Networks (EMNet) system is composed of two-applications, the EMNet Manager application, which will be installed in the teacher station and will manage students' computers in the network (with a Student Desktop component installed in the student stations); and a Lesson Builder application, which will be installed in the teacher station or other computer resource and which will build lesson for the class. Each lesson would have the Lesson Plan, Content and Evaluation. The teacher station will act as a server; and the student stations function as clients of a network.

The Educational Manager for Networks is a system designed to administrate a class in a network and maintain control of the computerized resources in the classroom. The study curriculum becomes interactive, so the teacher can captivate the attention of the students, keeping control of the classroom at every moment and make the content very relevant to the students. The teacher has the opportunity of create a lesson with the system and work the lesson content with the students.

The teacher will determine in which moments of the class the students will have access to their computers and which of the available resources the students can use. In this manner, all of the students can work at their own pace, individualizing the learning of any subject. At the same time, the teacher will be able to monitor the work of every student in an independent form.

The system enables the teacher to structure lesson content, distribute different lesson content to every student, create and correct exercises, manage access of the student systems, and make Internet a safe and educational tool for students by controlling the Internet addresses to which the students have access to. In this context, the teacher can add to the system those addresses that the students can visit. By controlling student systems, the system can restrict the use of the students' computers and the teachers can maximize their time. The teacher can let the students work only with EMNet software, or let the student to have free access when the teacher wants it. The system also enables screen sharing between the teacher and students, students and teacher, or individually from teacher to selected student, selected student to teacher, or selected student to teacher and other students. This allows the classroom to become a knowledge sharing environment where there is no time wasted because any computer screen could be shared at any time without moving from their seats.

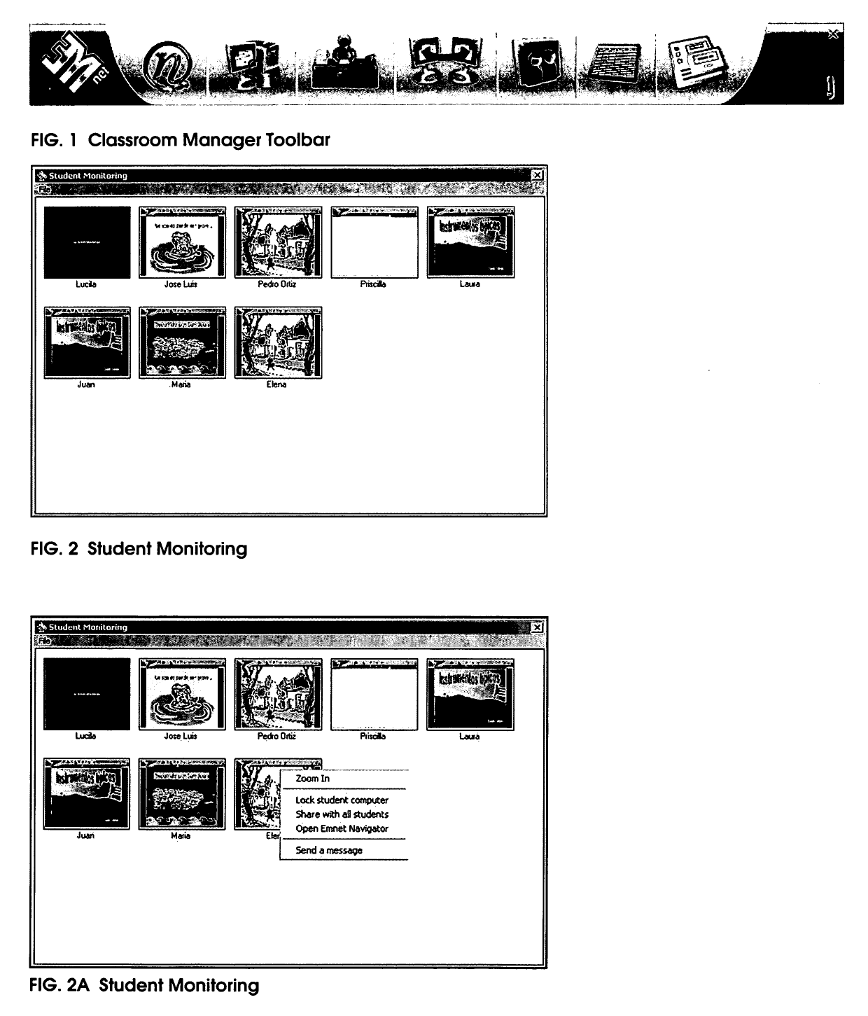

The EMNet Manager application is installed in the station that will manage the network, i.e., the teacher station. To have access to the EMNet Manager application, the user clicks on the icon that will appear in the computer desktop after installing the application. You can also access it by clicking START-Programs-Educational Manager for Networks. By accessing the Educational Manager for Networks application, a toolbar will appear with options in the computer desktop. See FIG. 1. This toolbar will be shown only in the manager station. The toolbar icons are represented as:
1. EMNet Navigator
   Open my navigator
   Select single student navigator
   Open navigator to every student
   Close navigator to all students
2. Student Privileges
   Lock all student computers
   Unlock all student computers
   Lock individual student computers
   Disable the Windows Start Menu
3. EMNet Lesson Builder
   Build a new lesson
   Edit a lesson
   Preview a lesson
   Open a lesson for all students
   Individual student lessons
   Close all running lessons
4. Screen Sharing
   Share my computer
   Share a student computer
5. Monitor Students
   Zoom in
   Lock student computer
   Share with all students
   Open EMNet Navigator
   Send a message
6. Rollbook
7. Configuration Settings
   Internet Settings
   Screen Sharing Settings
   Network Settings
   About Us
8. Lock or Unlock the Toolbar
9. Exit
   Leave the Student Desktop running
   Close the Student Desktop
   Shutdown student computers

The EMNet Internet Navigator icon will give the teacher two opening and closing options as (1) open or close a browser in the administrator station (Open my EMNet Browser), and (2) open or close the browser in the student station (Open/Close the Student EMNet Internet Navigator). If at one moment the teacher wishes that the students use the Internet resource, click the icon and select the action you wish to perform.

In order to close the Internet browser click the icon again and select the option Close Student EMNet Internet Navigator. This will close automatically the Internet in the stations of all of the students in the network. The steps to open and close the Internet browser of the administrator station are similar to the steps that the teacher follows to work with the student browser. The teacher can close his/her browser clicking the X that appears at his/her right side.

The Student Privileges icon option for Lock the student the computers gives the teacher the opportunity to control the work stations of the students. The teacher will decide if he allows access to the computer or to restrict it in a specific time of the class. To activate this option, the teacher will click the Student Privileges icon and select the option “Lock the student computers” in the administrator station. To allow access again, the teacher clicks the same icon. In the menu of options that this icon provides access to, the teacher can allow or restrict the use of Microsoft Windows, using the option Disable the Windows Start Menu. When the teacher selects the option Disable the Windows Start Menu to thereby enable access, the students will have access to Microsoft Windows and any applications that are installed in the computer, and they will see the variety of tools from Microsoft Windows. When activated, a check mark at the left side of the option will disappear. If access to Microsoft Windows is restricted again, the checkmark will appear at the left side of the option Disable the Windows Start Menu, and the students only will see the status bar of the EMNet Student Desktop and their desktop screen without any other icon.

The EMNet Lesson Builder allows the teacher to structure, edit, send, distribute and stop a lesson at the same time the lesson is being given to the students. The teacher can use the tools that are often used to enrich and create their lessons, like word processing applications, spreadsheet applications and presentation tools and multimedia files. The teacher will make a compilation of these files in one package to turn it into an EMNet file, and from the EMNet application the teacher can distribute his/her lesson. The files inside the EMNet package will run in the order in which the lessons were added. Details on how to structurate, edit, send, distribute and stop a lesson from the EMNet Manager will be described below.

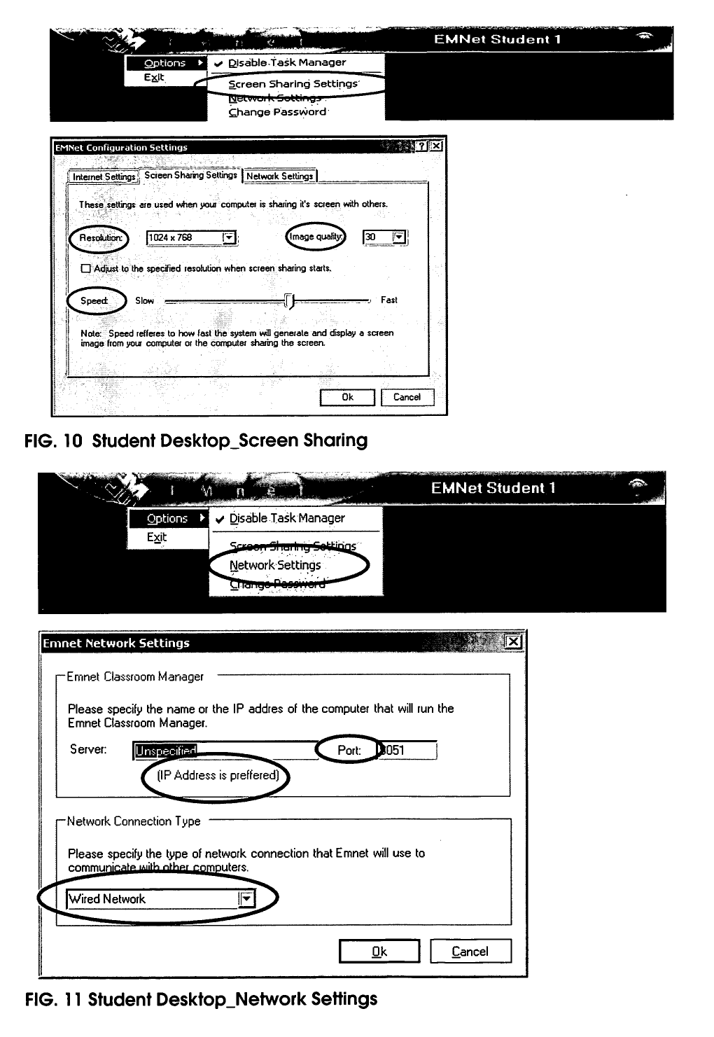

The Screen Sharing option allows the teacher to share with all the stations connected to the network the images that are in his/her screen or the ones in the selected ones or all of the students' screens. See, e.g., FIG. 10. The teacher will decide when he/she will share screens, which screen will be shared, and when to stop the process. If the teacher wants the students to see what is being worked on in his/her screen, the teacher can click the icon and select the option Share my computer from the menu that will appear, without the need of using a projector. Automatically, the teacher's screen will be displayed in the stations of all the students in the network. In the same way, if the teacher wants to share the screen of one of the students to the rest of the group, the teacher selects the option Share a student computer and selects the computer of which the screen will be shared.

The Monitor Students icon allows the teacher to view what the students are doing. The system refreshes the image of every computer in the network over a set time period, from five to seven seconds. By selecting this option the teacher will see a screen with the images of the screen of all of the students in the network in small squares, as is shown in FIG. 2. The Monitor Students feature may include additional options. Clicking on any student monitor image displays the following options: Zoom in, Lock student computer, Share with all students, Open EMNet Navigator, Send a message, as is shown in FIG. 2a. The Zoom in option allows the teacher to view in full size the student's display. This display is updated periodically on the teacher's computer. Lock student computer immediately blocks the selected student computer. Share with all students, shares the selected student computer with the rest of the students. Open EMNet Navigator opens the Navigator to the selected student computer. Send a message opens a chat session with the selected student computer. A chat application permits the exchange of messages between the teacher and the student with the optional capability of exchanging messages between students. A chat user can choose to establish a conversation with one or more users connected to the system. All users are listed as contacts, and such list can be hidden from view or shown again. The visibility of the contact list on the student screen can also be controlled by the teacher providing an effective means of controlling the student to student messages. The system alerts of a new incoming messages not read by the teacher. Users are able to configure the text appearance on the display.

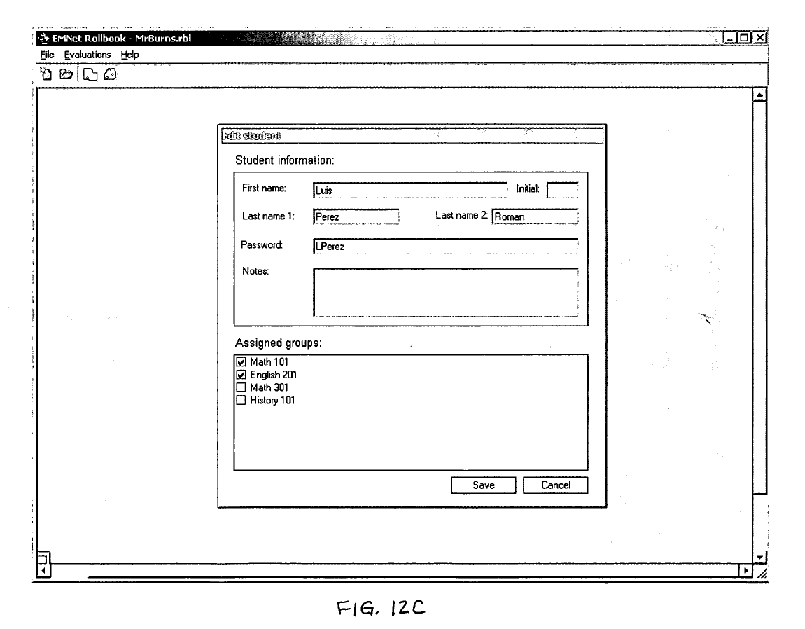

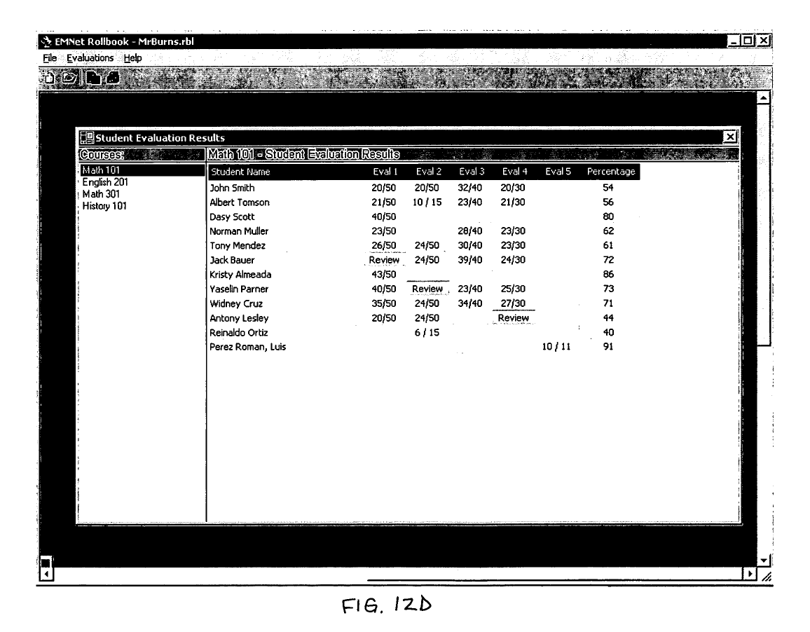

The system includes a Roll Book function that allows the teacher to simplify and digitally organize his or her courses and students. See, e.g., FIGS. 12A-D. Through the use of this application teachers create an EMNet Roll Book file, which is identified by the “.rlb” filename extension. Such file is then populated with information about courses, students, schedules and evaluation results. The file data is structured and stored as raw XML data, thus making the file extensible, portable and compatible with other EMNet compatible applications.

The main window contains corresponding menus to create, open and close an EMNet Roll Book. Once a Roll Book file has been opened or created, teachers can add, edit and remove courses through the Manage Courses Window. This window also displays a list of courses, students assigned to each course, and allows the addition, modification and removal of student profiles.

The Add and Edit Course window can be used to specify the course name, description, section and level. This window also allows the course to contain a detailed schedule, which includes start and end times, and the days of the week where it occurs.

The Add and Edit Students window can be used to create a student profile. It also allows the teacher to assign and reassign his students to one or more courses.

The View Evaluation Results window displays a grid that contains a list of every evaluation that was administered to students under each of the courses during the lifetime of the Roll Book. By selecting a course from the course list on the left of the screen, the corresponding evaluation results are dynamically displayed on the right side of the screen. The resulting score of every evaluation is shown on the grid boxes, and evaluations that are not automatically processed are marked with the Review keyword. The teacher can review each evaluation by double clicking the corresponding grid box containing the score or the Review keyword. The percentage of each student is also displayed at the end of each student row.

An Evaluation Viewer window allows the teacher to review, correct, save, comment, and export student evaluations. While multiple choice and match exercises are automatically evaluated, open questions are manually reviewed and value points can be assigned, permitting the teacher determine whether the exercise is absolutely or partially correct or incorrect.

The options provided by the icon Configuration Settings include Internet Settings, Screen Sharing Settings, Network Settings, and About.

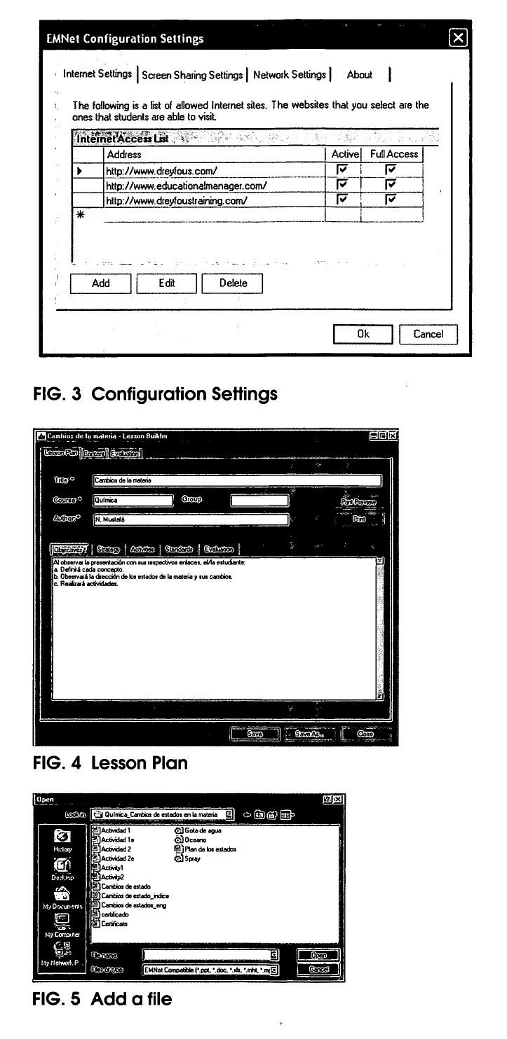

Another function provided by the Internet Settings option is adding the address of an Internet page. In the Internet Settings, window shown in FIG. 3, the teacher selects on an Internet Access List the addresses of the Internet pages that he/she wishes to make accessible to the students. In this way, the students will see only those electronic addresses that are selected with a checkmark at the left side of the address. They could navigate in them when permitted by the teacher. The teacher may click to add a check in the square that says Full Access. To exit this screen saving the changes that were made, the teacher clicks the OK button or CANCEL if the teacher doesn't want to save the changes. To delete an address on the list, the teacher selects the address that he/she wishes to erase and presses Delete. After writing the electronic address of the Website in the Address area, the teacher selects Add to List to save the link. To exit the window, the teacher clicks the Close button.

The Screen Sharing Settings option is accessed via the Configuration Settings icon. The teacher has the option to configure the quality of the image being shown to the students as well as its size. In a network where various services run, and at the same time has a group of work stations connected, the movement of the data packages may be a little slow. This option enables the teacher to sacrifice image quality for increased network speed. To save any changes made to the configurations of the Sharing Screen click the Ok button, to cancel it click the Cancel button.

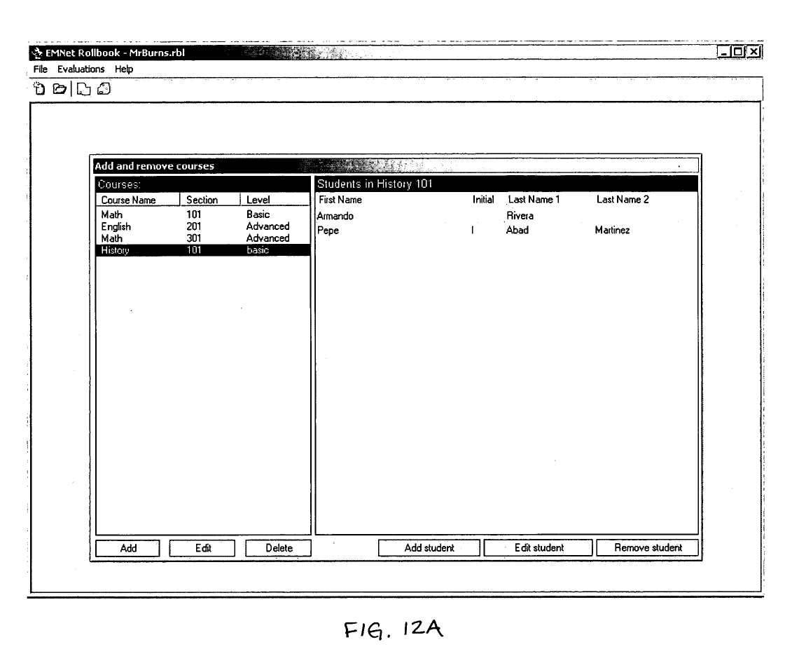

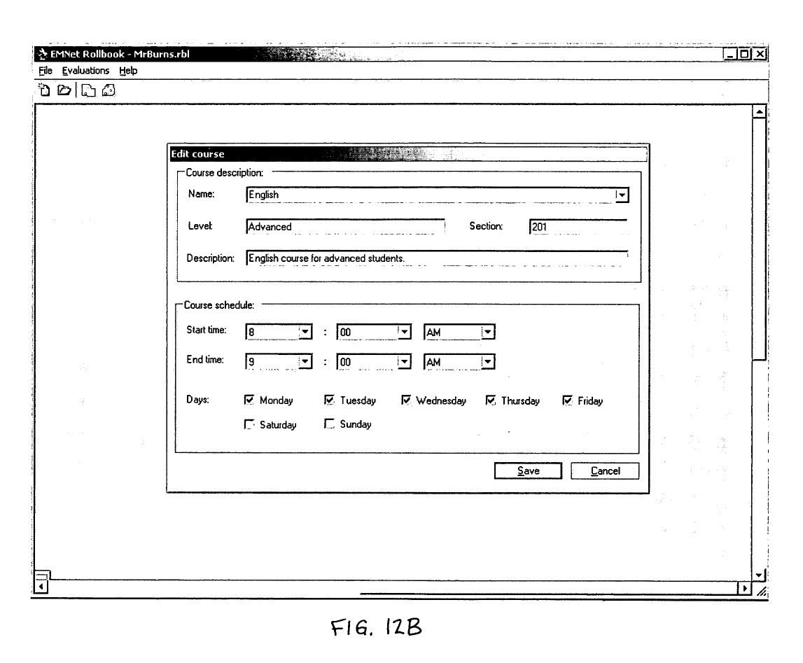

The Network Settings option is provided so the teacher can easily identify the Internet Protocol. See, e.g., FIG. 11. To access this option, select Internet Settings, and a screen is displayed showing the IP Address or computer name, either one which must be copied in each of the students' stations so all of them have the same address of the station that will manage the network and permit them to communicate. This way, the student stations will be managed by the teacher station. This process will be explained in more detail below. The About section provides general information such as company information.

The Student Desktop loads automatically once it is installed in the students' stations. The EMNet Student Desktop includes two parts: (1) Status Bar, and (2) Desktop.

The Windows Task Manager provides information about the programs and the processes that are running on one computer and their capacity. Next a Windows Task Manager illustration is displayed. In order to access to the Window Task Manager, the key combination Ctrl. +Alt +Delete is depressed. The Task Manager can be used to indicate the status of a program that is running or to close programs that are not responding. Therefore, it is beneficial to have access to it. On the other hand, if a student gains access to the Windows Task Manager, the student could try to stop a program or process that is running in their station. In case the teacher notices that a student has access to the Windows Task Manager and is trying to stop the EMNet Student Desktop (or other application), the teacher can deactivate or activate this option on the student computer. This option is also included in case any operation is needed to be performed in which the Windows Task Manager is present.

In order to activate the option Disable Task Manager (see FIG. 9) and to disallow student access, these steps are carried out: (a) select the station in which you would like to activate or to deactivate the Windows Task Manager; (b) press the EMNet logo that appears on the left side of the EMNet Student Desktop (this menu is password protected to ensure that only the teacher has access to it); and (c) go to the menu that will appear and select the Disable Taskbar option and select to deactivate it. In order to rehabilitate the Windows Task Manger or to make it accessible again, click on the previous option again. Note that the mark at the left side of the option will disappear, indicating that the option is no longer activated.

The teacher can adjust the quality in which their students will share their screens in the network. As noted above, reduced quality transmissions can increase network speed. In order to adjust and modify this option, the teacher follows the these steps: (a) Press the EMNet logo that appears at the left of the EMNet Status Bar on the EMNet Student Desktop (this menu is password protected to ensure that only the teacher has access to it); and (b) from the menu that will appear, select the Screen Sharing Settings option to see the different options that are offered. Once selected, a screen will be displayed in which the quality of the image that the student will share can be adjusted. In order to keep the changes made, press the Ok button.

Under the Network Settings option, the teacher will indicate to the EMNet Student Desktop the IP (Internet Protocol) or computer name of the Manager Computer (the one that installed EMNet manager), so that the teacher can take control of the students computers. The IP indicates to the students' computers which work station controls computers on the network, like an address to be followed. In order to set the IP, a number of steps are performed: (a) press the EMNet logo that appears on the left side of the Status Bar of the EMNet Student Desktop (this menu is password protected to ensure that only the teacher has access to it); (b) from the menu that will appear, select the Network Settings option to see the different options it offers; (c) next, a screen in is displayed in which the IP address of the Manager Computer is specified, so that the student computer can connect to the teacher station (Manager).

If necessary, the teacher can change the password to access the EMNet Student Desktop menu via these steps: (a) press the EMNet logo that appears at the left side of the EMNet Student Desktop Status Bar (this menu is password protected); (b) in the menu that will appear, select the Change Password option; and (c) make the changes and press the OK button to save.

To close the EMNet Student Desktop from one of the students' computers, (a) press the EMNet logo that appears at the left side of the EMNet Student Desktop Status Bar (this menu is protected by a password); and (b) from the menu that will appear, select the Exit option to close the program.

In order to restrict a student's computer access (Lock Student Computers), first select the Student Privileges icon on the EMNet Manager Toolbar in the teacher station, and click on the option entitled Lock all student computers. Automatically, the computers of all the students in the network will be restricted. If this option is activated, the students will see a ‘locked' message in their screens, and they will not be able to continue working in their computers until the teacher gives them access. The students will not lose any type of information when activating this option. To allow the students to access to their computers, press the Unlock all student computers option. Automatically, the computer resources are available for each student on the network. This option is also available for each student selecting Lock individual student computers from the menu.

In order to allow student access to the Internet, select the icon via the EMNet Manager Toolbar, and select Open Students EMNet Internet Navigator option. This option is also available for each student by selecting Select single student navigator from the menu. To restrict access, select Close navigator to all students option. Automatically, the Internet browser of the EMNet application closes itself in each one of the students' computers on the network.

In order to share screens with the students (EMNet Screen Sharing), the teacher (a) opens the program, document, image or work in the teacher computer (the one who has EMNet Manager installed), that is to be shown to the students before activating the Screen Sharing option. Click the Screen Sharing icon, then select the first option entitled Share my computer. When activating the option, the teacher's screen will be reflected in the monitors of all the students on the network. In order to deactivate this option, click the icon again and next a message is displayed asking if the teacher intends to stop screen sharing with the students. If the answer is affirmative, click OK.

In order to share a student computer screen, click the EMNet Screen Sharing icon. From the menu that appears, select Share a student computer, then select the station that is to be shared from the list. The student computer selected is projected on the computers of the rest of the students on the network, as well as in the teacher's computer. In order to stop sharing computers, click the EMNet Screen Sharing icon again, and click the OK button in the window.

The system may allow or prevent access to the Windows Start Menu, thereby enabling the students to work with the programs installed on their computer. Select and click the Disable the Windows Start Menu icon of the EMNet Manager Toolbar. Immediately, the students will see in their monitors the Microsoft Windows Start Menu, as well as the icons of Microsoft Windows in their desktops. To restrict the use of Microsoft Windows and the programs that your students have installed in their computers, click the icon again and select the Disable the Windows Start Menu option. Your students will see their desktop completely cleaned.

The system allows the teacher to monitor the students (Student Monitoring). In order to initiate student monitoring, (a) select the Monitoring Students icon from the EMNet Toolbar; (b) after which, automatically, in the Manager Computer would appear small boxes with the screens of all the computers connected to the network, as shown in FIG. 2. To stop monitoring the students, simply close the window.

An important benefit of the system of the present invention is the ability to create and distribute lessons created by the teacher. A lesson is created using common programs like word processing applications, spreadsheet applications, presentation tools and multimedia files. This feature makes the content creation a very easy one to a technology non-expert therefore allowing teachers from any subject matter to create and modify their own educational materials and incorporate their own photos, videos, any multimedia file, web pages, presentation files, word processing files and spreadsheet files. Once a lesson is saved all the files within the lesson are packed into just one file. After the lesson is created the teacher can distribute to one or more students from the teachers computer, making this process a very individual one. To use this feature select the icon to build lessons (Lesson Builder) from the EMNet Manager Toolbar. From the menu that appears, select the Build a new lesson option. Once selected, the next window entitled EMNet Lesson Plan is displayed. In this window, the lesson base is described to populate the fields such as:

Title

Course

Author

Objectives

Strategy

Activities

Standard

Evaluation

This window also brings you the option to see a previous Lesson Plan before printing. To save the lesson, press the button labeled Save as. If this button is clicked, the program will ask in which place the lesson should be saved, and the created Lesson Plan is displayed. See FIG. 4. Click the Content tab to add files to the lesson. When this option is selected, the next window is displayed, in which files can be added to a lesson. To add a web site to the lesson, click the Add a webpage button, and a window is provided in which the web site that being added can be referenced. Click the Add to List button to add it.

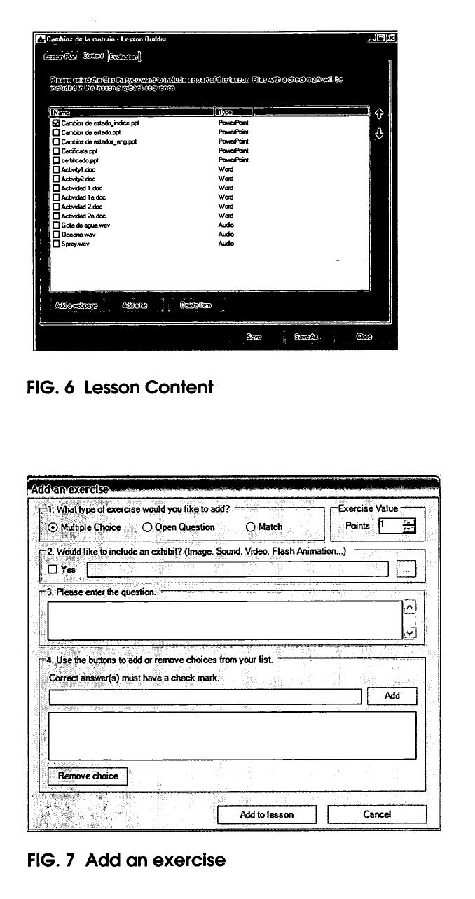

To add a file to the EMNet lesson, click the “Add a file” button. The window of FIG. 5 will be displayed showing the locations of the lesson files to add. Select the file and click the “Open” button to add it. As files are added, they will be contained in the “Lesson Content”, as shown in FIG. 6.

The order in which the files will run when running your lesson can be changed by using the arrow buttons, that you will see at the right side of the window. If you want to delete a file from the list, select the file and click the Delete button. To save the change made or the files added click the Save Lesson button and click Cancel button to cancel it.

To create an EMNet evaluation or test, select the EMNet Lesson Builder icon, and select the lesson that to which exercises should be added. In the Lesson Plan that will appear, select the Evaluation tab, choose the Add an exercise option, and define the type of evaluation desired, e.g., Multiple Choice, Match and Open Questions. See FIG. 7.

If Multiple Choice is selected, assign points in the Exercise value window, then write the question in the space provided. Click the Add button to add different choices to the question; then, add a checkmark to the correct answer. To finish the process, click the Add to lesson button. Click the Add an exercise button to add more exercises, or select the exercise. Select edit exercise to modify an exercise. To delete an exercise, select the exercise and press the Delete button. Select an exercise and click the arrow buttons to change the order when running the lesson.

If Open Question is selected, write the question in the space provided, then assign the value of the question. The teacher will evaluate these questions manually. To finish the process, click the Add to lesson button. Write the instructions to the exercises added to the lesson by clicking the Add Instructions button in the Evaluation Window. Then, click the Browse button in the previous window to choose the file where the student results will be stored. A previously made file can be selected or a new one can be created. Put the checkmark on if the lesson should be hidden when the students take the evaluation. To save the lesson click the Save Lesson button.

If Match is selected, write the statement in the space provided. The teacher can type a series of correct matching values on the designated columns. When the lesson runs, it will shuffle automatically the concepts to be matched. The points can be added in the Exercise Value area. To finish the process, click the Add to lesson button.

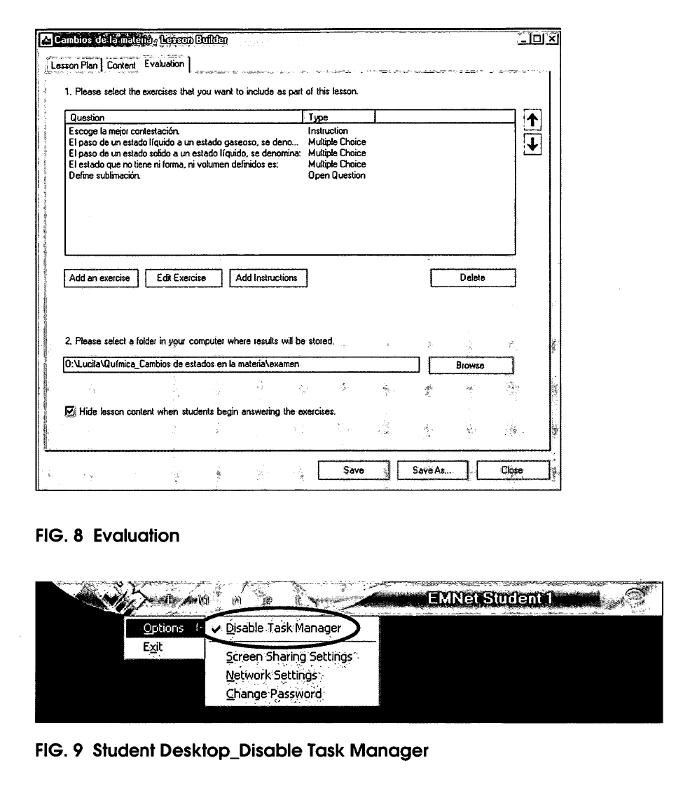

Once created, the exercises are presented to the students in the designated order. See FIG. 8. When the students receive the lesson, a message will appear on each of the students' computers letting them know that the lesson includes exercises. Once the students answer the exercises they must click the Finished button to send those results to the Manager Computer. The teacher will receive the answers in his/her computer in the file previously configured.

In order to edit a lesson, select the EMNet Lesson Builder icon from the EMNet Manager Toolbar. To add documents, files and website addresses, click the Edit a lesson button. Find the name of the EMNet file on the computer and click the Open button. Once the lesson is opened, the Lesson Plan Window is displayed. To add files, click the Content tab to edit the lesson.

A lesson may be previewed by selecting the preview option, where the lesson will only run in the Manager Computer, so that the teacher will have the option to review the lesson before sending it to the students. To run a lesson, select the Lesson Builder icon from the EMNet Toolbar and click the Open a lesson for all students. From the displayed list of lessons, click the Open button to run the desired lesson.

To stop the EMNet Manager program, click the close button on the EMNet Manager Toolbar. A window will be displayed with exit options. If Leave the Student Desktop Running is selected, the EMNet Manager application will close and the Student Desktop will be hidden from view. If the EMNet Manager application is opened again, the Student Desktop applications will be visible again. If Close the Student Portal is selected, the EMNet Manager and the Student Desktop applications will exit. If Shutdown the Student Computers is selected, the students' computers will shut down automatically.

The system has the option to close the EMNet Student Desktop on the students computer. To do this, press the EMNet logo that appears on the left side of the Status Bar of the EMNet Student Desktop (this menu is password protected). The program will automatically close.

Also incorporated into the EMNet system is the ability to establish a direct and dynamic link between teachers and students around the world. The Educational Manager for Networks application is functional over a Wide Area Network such as the Internet. This makes it possible to pull together a heterogeneous virtual online classroom composed of students from local and remote locations. The EMNet Student Desktop application can be easily configured to connect to a remote EMNet Classroom Manager application sitting on distant locations across the Internet. Once the teacher and students have established a connection, the student computers are able to respond to commands such as Computer Lock, Screen Sharing, Student Monitoring and, Application Control, among others. Teachers are also able to create and send individualized EMNet Lessons to students and gather results from corresponding EMNet Evaluations.

The following spreadsheet details the system modules by section, action and expected output.

| Case | | | | |
|---|---|---|---|---|
| ID | Module | Section | Action | Expected Output |
| 4.001 | Activation Wizard | Start Up | User double clicks on | a. The Classroom Manager application launches, and attempts to confirm if |
| | | | the Classroom Manager | the software has been activated. |
| | | | icon. | b. If the software has been activated, the Classroom Manager will continue |
| | | | | to launch. |
| | | | | c. If the software has NOT been activated, the activation wizard will be |
| | | | | displayed to the user. The first screen will contain a welcome message and |
| | | | | Next and Cancel buttons. If the user clicks cancel at any time, the wizard will |
| | | | | end and the Classroom Manager application will not launch. |
| 4.002 | Activation Wizard | First Screen | User clicks on the Next | a. A second window is displayed prompting the user to provide the LSN. |
| | | | Button. | |
| 4.003 | Activation Wizard | Second | User clicks on the Next | a. A third window is displayed delivering to the user a Confirmation ID inside |
| | | Screen | Button. | a text box. The user is indicated to provide such Confirmation ID to a |
| | | | | Customer Service Representative (CSR). |
| | | | | b. An Activation Key text box is available to the user, where he/she must |
| | | | | enter the Activation Key provided by the CSR. |
| 4.004 | Activation Wizard | Third Screen | User clicks on the Next | a. The activation wizard will attempt to activate the software. |
| | | | Button. | b. If the activation is successful, the activation related data will be stored |
| | | | | inside an XML file inside a common folder accessible by other software |
| | | | | products created by Dreyfous & Associates. |
| | | | | c. If the activation process fail, the user will be prompted indicating the |
| | | | | failure. User must be allowed to handle more intents. |
| 4.005 | Activation Wizard | Validation | The time of the software | a. A message will notify the user indicating that the software must be |
| | | Tasks | subscription expires. | reactivated in order to continue. |
| 5.003 | Classroom | Classroom | Teacher clicks on any of | a. A context menu is displayed except for Monitor Students and Settings |
| | Manager | Manager | the buttons contained in | buttons. |
| | | Toolbar | the Toolbar. | |
| 5.005 | Classroom | EMNet | Teacher mouses over | a. The Student EMNet Navigator is opened in the selected student's |
| | Manager | Navigator | the Select Student | computer. If the navigator is already opened, it will be closed instead. |
| | | button | Navigator and clicks on | |
| | | | the name of a student. | |
| 5.006 | Classroom | EMNet | Teacher clicks on the | a. The Student EMNet Navigator will opened in every student computer. |
| | Manager | Navigator | Open navigator to every | |
| | | button | student menu item. | |
| 5.007 | Classroom | EMNet | Teacher clicks on Close | a. The Student EMNet Navigator will close in every student computer. |
| | Manager | Navigator | navigator to all students. | |
| | | button | | |
| 5.008 | Classroom | Student | Teacher clicks on the | a. All the student computers display a blue screen indicating that their |
| | Manager | Privileges | Lock all student | system has been locked. |
| | | button | computers menu item | |
| 5.009 | Classroom | Student | Teacher clicks on Unlock | a. All the student computers get unlocked and the blue screen hides. |
| | Manager | Privileges | all student computers | |
| | | button | menu item. | |
| 5.010 | Classroom | Student | Teacher mouses over | a. The selected student computer will be locked or unlocked otherwise. |
| | Manager | Privileges | the Lock individual | |
| | | button | student computer menu | |
| | | | item and clicks on the | |
| | | | name of a student. | |
| 5.011 | Classroom | Lesson Builder | Teacher clicks on the | a. The EMNet Lesson Builder launches, displays a splash window and |
| | Manager | button | Build New Lesson menu | prompts the teacher with a menu to build a new lesson, open a lesson, and |
| | | | item. | work with an evaluation. |
| 5.012 | Classroom | Lesson Builder | Teacher clicks the Edit a | a. A file open dialog will show prompting the teacher to locate the lesson. |
| | Manager | button | lesson menu item. | b. After the teacher selects a file, Lesson Builder will attempt to open the file. |
| | | | | If the file is an compatible, will be displayed. The teacher will be prompted to |
| | | | | build a new lesson file otherwise. |
| 5.013 | Classroom | Lesson Builder | Teacher clicks on the | a. A file open dialog will show prompting the teacher to locate the lesson. |
| | Manager | button | Preview Lesson menu | b. Once the teacher selects a file, the lesson is opened in a new instance of |
| | | | item. | the Student Navigator. The teacher is allowed to view the progress of the |
| | | | | lesson and any evaluations included within. |
| 5.014 | Classroom | Lesson Builder | Teacher clicks on Open | a. A file open dialog will show prompting the teacher to locate the lesson. |
| | Manager | button | a lesson for all students | b. After the teacher selects a file, the lesson is opened in a new instance of |
| | | | menu item. | the Student Navigator containing the lesson in every student computer. |
| 5.015 | Classroom | Lesson Builder | Teacher mouses over | a. A file open dialog will show prompting the teacher to locate the lesson. |
| | Manager | button | Individual student | b. After the teacher selects a file, the lesson is opened in a new instance of |
| | | | lessons menu item and | the Student Navigator containing the lesson in the selected student |
| | | | clicks on the name of a | computer. |
| | | | student. | |
| 5.016 | Classroom | Screen | Teacher clicks on the | a. The teacher's screen size will adjust depending on the Screen Sharing |
| | Manager | Sharing button | Share my computer | Settings to the specified resolution. |
| | | | menu item when a | b. If Student Monitoring window is opened the teacher will be prompted |
| | | | screen sharing session | indicating that student monitoring should be stopped and it will be closed. |
| | | | is not in progress. | c. Every student computer will be allowed only to receive the images from |
| | | | | the teacher's screen. This is referred to a as screen sharing session. |
| | | | | d. Otherwise, if a screen sharing session is already in progress, the teacher's |
| | | | | screen size will adjust to the original resolution. Every student computer will |
| | | | | stop receiving the images from the teacher's screen. |
| 5.017 | Classroom | Screen | Teacher mouses over | a. The selected student computer's screen size will adjust depending on the |
| | Manager | Sharing button | Share a student desktop | Screen Sharing Settings to the specified resolution. All other students will |
| | | | menu item and clicks on | begin (and only be allowed) to receive the screen images from the selected |
| | | | the name of a student. | student screen. |
| | | | | b. The teacher will also start to receive the screen images from the selected |
| | | | | student. If the teacher closes the window that is displaying the student |
| | | | | screen, ends the screen sharing session. |
| 5.018 | Classroom | Screen | Teacher clicks on the | a. A message box will confirm the teacher's intentions of stopping the screen |
| | Manager | Sharing button | Stop Screen Sharing | sharing session. |
| | | | button (possible only | b. If the teacher clicks the OK button, the screen sharing session will be |
| | | | when there is an active | stopped. |
| | | | screen sharing session). | c. If the teacher clicks the CANCEL button, the screen sharing session will |
| | | | | stay active. |
| 5.019 | Classroom | Monitor | Teacher clicks on the | a. The Student Monitoring window will open. |
| | Manager | Students | Monitor Students button. | b. A message indicating that communication with the student computers is in |
| | | button | | progress is displayed. |
| | | | | c. If there are student computers configured to connect to the teachers |
| | | | | Classroom Manager, they will be displayed as thumbnails inside a scrolling |
| | | | | area. |
| 5.021 | Classroom | Student | Teacher keeps the | a. The thumbnails containing the student screens will be refreshed every |
| | Manager | Monitoring | student monitoring | three (3) seconds. |
| | | Window | window open. | b. If a new student connects to the system, a new thumbnail containing the |
| | | | | new student's screen will be added to the list of thumbnails. |
| | | | | c. If the student connection is lost an X appears in its place. |
| 5.022 | Classroom | Student | Teacher clicks on any of | a. A context menu is displayed containing the following menu items: |
| | Manager | Monitoring | the thumbnails inside the | Zoom in - |
| | | Window | scrolling area. | Lock student computer |
| | | | | Share with all students |
| | | | | Open EMNet Navigator |
| | | | | Open Taskbar |
| | | | | Send a message |
| 5.023 | Classroom | Student | Teacher clicks on the | a. A new window with an enlarged view of the selected student's screen is |
| | Manager | Monitoring | Zoom in context menu | displayed. This view is refreshed every three (3) seconds. |
| | | Window | item. | |
| 5.024 | Classroom | Student | Teacher clicks on the | a. The selected student computer will be locked or unlocked otherwise. |
| | Manager | Monitoring | Lock student computer | b. A check mark indicating whether the student computer is locked or not is |
| | | Window | context menu item. | displayed under this menu item. A check mark under is also placed under |
| | | | | the selected student's name, in the context menu item related to the Student |
| | | | | Privileges button. |
| | | | | c. This check marks should be consistent and persistent across the |
| | | | | classroom manager application. |
| 5.025 | Classroom | Student | Teacher clicks on the | a. The selected student computer's screen size will adjust depending on the |
| | Manager | Monitoring | Share with all students | Screen Sharing Settings to the specified resolution. All other students will |
| | | Window | context menu item. | begin (and only be allowed) to receive the screen images from the selected |
| | | | | student screen. |
| | | | | b. The teacher will also start to receive the screen images from the selected |
| | | | | student. If the teacher closes the window that is displaying the student |
| | | | | screen, ends the screen sharing session. |
| 5.026 | Classroom | Student | Teacher clicks on the | a. The Student EMNet Navigator is opened in the selected student's |
| | Manager | Monitoring | Open EMNet Navigator | computer. If the navigator is already opened, it will be closed instead. |
| | | Window | context menu item. | b. A check mark indicating whether the student EMNet navigator is opened |
| | | | | in the student computer is displayed next to the menu item, and the context |
| | | | | menu item under EMNet Navigator context menu on the main Toolbar. |
| 5.027 | Classroom | Student | Teacher clicks on Send | a. A Messenger (Chat) Window will be displayed. |
| | Manager | Monitoring | a Message context | b. If the teachers writes a message and clicks on the Send button, the |
| | | Window | menu item. | selected student will receive the message in an instance of the same |
| | | | | window. |
| | | | | c. The student should be able to reply. |
| | | | | d. All messages should be received, even if the message window is closed, |
| | | | | in which case it will be reopened. |
| 5.029 | Classroom | Configuration | Teacher clicks on the | a. A Web Browser window is displayed. |
| | Manager | Settings | Add button. | b. Teacher can use the browser to navigate to any Internet address by typing |
| | | Window - | | the URL and hit the ENTER key or pressing the GO button, and use the |
| | | Internet | | corresponding buttons to navigate back and forward. |
| | | Settings | | c. Once the teacher decides which URL to include in the list of available |
| | | | | Internet addresses, clicks on the Select Website button. |
| | | | | d. If the teacher closes the window by clicking on the close (x) button, he/she |
| | | | | will be prompted to add the website to the list or disregard the navigation. |
| 5.030 | Classroom | Configuration | Teacher clicks on the | a. A Web Browser window is displayed containing the web page |
| | Manager | Settings | Edit button. | corresponding to the selected URL from the list. |
| | | Window - | | b. Teacher is allowed to navigate to a different Internet address. |
| | | Internet | | c. Once the teacher decides which URL to include in the list of available |
| | | Settings | | Internet Addresses, clicks on the Select Website button, and the selected |
| | | | | URL replaces the one that was intended to be modified. |
| 5.031 | Classroom | Configuration | Teacher clicks on the | a. The selected Internet address is removed from the list. |
| | Manager | Settings | Delete button. | |
| | | Window - | | |
| | | Internet | | |
| | | Settings | | |
| 5.038 | Classroom | Configuration | Default information. | a. A text box containing the name of the Teacher's computer is displayed. |
| | Manager | Settings | | b. A text box containing the IP address of the Teacher's computer is also |
| | | Window - | | displayed. |
| | | Network | | c. A text box containing the TCP port number that will be used to establish a |
| | | Settings | | network connection with the student computers. |
| 5.041 | Classroom | Visibility | Teacher clicks on the | a. The Classroom Manager Toolbar will hide if the pin button is unset |
| | Manager | | Pin button. | (represented with transparency) when the user mouses out or selects |
| | | | | another application. The Toolbar will reappear if the user mouses over to the |
| | | | | top of the screen. |
| | | | | b. The Classroom Manager Toolbar will stay visible on top of every other |
| | | | | running application if the pin button is set (no transparency). |
| 6.001 | Lesson Builder | Start Up | Teacher double clicks on | a. The Lesson Builder application launches. |
| | | | the Lesson Builder icon. | b. A splash window containing the version number and the copyright notice |
| | | | | is displayed. |
| | | | | c. Once the application is up and running, it will display a centralized window |
| | | | | containing a menu with the following options: |
| | | | | Create a new lesson |
| | | | | Open a lesson |
| | | | | Work with an evaluation |
| | | | | d. A main menu at the top of the screen will also contain the following menu |
| | | | | items: |
| | | | | File -> Create a new lesson |
| | | | | File -> Open a lesson |
| | | | | File -> Evaluation viewer |
| | | | | File -> Exit |
| 6.002 | Lesson Builder | Menu Options | Teacher clicks on the | a. The Create Lesson window will be displayed to the teacher. |
| | | | Create a new lesson | |
| | | | menu option. | |
| 6.003 | Lesson Builder | Menu Options | Teacher clicks on the | a. A file open dialog will show prompting the teacher to locate the lesson. |
| | | | Open a lesson menu | b. After the teacher selects a file, Lesson Builder will attempt to open the file. |
| | | | option. | If the file is compatible, will be displayed in a new instance of the Create |
| | | | | Lesson window. The teacher will be prompted to create a new lesson file |
| | | | | otherwise. |
| 6.004 | Lesson Builder | Menu Options | Teacher clicks on the | a. The Evaluation Viewer window will be displayed. |
| | | | Evaluation viewer or | b. A second menu category will be displayed inside the main menu of the |
| | | | Work with an evaluation | MDI window form containing the following menu options: |
| | | | menu options. | Evaluation -> Open |
| | | | | Evaluation -> Save (disabled by default) |
| | | | | Evaluation -> Export to HTML (disabled by default) |
| | | | | Evaluation -> Print (disabled by default) |
| | | | | Evaluation -> Close Evaluation |
| 6.005 | Lesson Builder | Create Lesson | Teacher clicks on the | a. The following fields will be available to the teacher: |
| | | Window | Lesson Plan tab. | Title - as single line text box |
| | | | | Course - as single line text box |
| | | | | Group - as single line text box |
| | | | | Author - as single line text box |
| | | | | Objectives - inside tab as multiple line text box |
| | | | | Strategy - inside tab as multiple line text box |
| | | | | Activities - inside tab as multiple line text box |
| | | | | Standards - inside tab as multiple line text box |
| | | | | Evaluation - inside tab as multiple line text box |
| 6.008 | Lesson Builder | Create Lesson | Teacher clicks on the | a. A list box will be displayed, to be used as the list of documents and |
| | | Window | Content tab. | websites to include inside the lesson. |
| | | | | b. The following buttons are also available: |
| | | | | Add a web page |
| | | | | Add a file |
| | | | | Delete item |
| | | | | UP and DOWN arrows |
| 6.009 | Lesson Builder | Create Lesson | Teacher clicks on the | a. An Internet browser will be displayed. The teacher should be able to |
| | | Window - | Add a web page button. | navigate and select the website that is to be included in the lesson by |
| | | Content | | clicking on the select website button. |
| | | | | b. Once the teacher clicks on the Select Website button, the URL will be |
| | | | | added to the Content List. |
| 6.010 | Lesson Builder | Create Lesson | Teacher clicks on the | a. An open file dialog is displayed. The teacher should be able to locate a file |
| | | Window - | Add a file button. | with any of the following file extensions: |
| | | Content | | ppt - Power Point |
| | | | | doc - Word Document |
| | | | | xls - Excel Document |
| | | | | mht - Internet Explorer compressed web page |
| | | | | mpg - Movie file format |
| | | | | wav - Sound file format |
| | | | | wmv - Movie and/or sound file format |
| | | | | jpg - image |
| | | | | mid - Musical Instrument Digital Interface file |
| | | | | midi - Musical Instrument Digital Interface file |
| | | | | b. Once the teacher clicks on the Open button, the file is embedded into the |
| | | | | lesson and gets added to the Content List. |
| 6.013 | Lesson Builder | Create Lesson | Teacher assigns or | a. If an item in the list is checked, indicates that it is meant to be included in |
| | | Window - | removes check marks | the lesson as a playback content item for the lesson. |
| | | Content | from the check boxes | b. If an item in the list is unchecked, indicates that this item should be |
| | | | next to the items in the | included as part of the content of the lesson, but it will not appear as a |
| | | | list. | playback content item for the lesson. |
| 6.014 | Lesson Builder | Create Lesson | Teacher clicks on the | a. The following fields will be available to the teacher: |
| | | Window | Evaluation tab. | List box containing the instructions and exercises |
| | | | | Text box containing the path of the folder where the results of the |
| | | | | evaluation will be stored. |
| | | | | A check box to indicate weather or not the Lesson Content will be available |
| | | | | to the student when taking the evaluation. |
| | | | | b. The following buttons will also be available: |
| | | | | Add an exercise |
| | | | | Edit exercise |
| | | | | Add instructions |
| | | | | Delete exercise |
| | | | | Browse |
| 6.015 | Lesson Builder | Create Lesson | Teacher clicks on the | a. A Create Exercise window will be displayed, where the teacher can do any |
| | | Window - | Add an exercise button. | of the following: |
| | | Evaluation | | Select between creating a Multiple Choice, a Matching exercise or an Open |
| | | | | Question |
| | | | | Specify the value of the exercise |
| | | | | Add attachments to the exercise |
| | | | | Write a question |
| | | | | Add and remove options |
| | | | | Identify correct answers |
| 6.016 | Lesson Builder | Create Lesson | Teacher clicks on the | a. The Create Exercise window is resized to a smaller view, and the teacher |
| | | Window - | Open Question radio | will only be allowed to provide the question, specify the value of the exercise |
| | | Evaluation | button. | and attach an exhibit. |
| 6.017 | Lesson Builder | Create Lesson | Teacher clicks on the | a. The teacher can increment or decrement the numbers in the text box. |
| | | Window - | Points numeric up/down | b. A manual entry can also be specified. |
| | | Evaluation | text box. | |
| 6.018 | Lesson Builder | Create Lesson | Teacher selects Yes in | a. A file open dialog will show prompting the teacher to locate the file to be |
| | | Window - | the include exhibit | included as an exhibit (attachment) for the exercise. |
| | | Evaluation | section, and clicks on | b. Once the teacher selects the file, it is embedded into the exercise, and the |
| | | | the Browse (represented | path to the file's location is displayed in the corresponding text box. |
| | | | as three dotted) button. | c. The teacher should be able to locate a file with any of the following file |
| | | | | extensions: |
| | | | | ppt - Power Point |
| | | | | doc - Word Document |
| | | | | xls - Excel Document |
| | | | | mht - Internet Explorer compressed web page |
| | | | | mpg - Movie file format |
| | | | | wav - Sound file format |
| | | | | wmv - Movie and/or sound file format |
| | | | | jpg - image |
| | | | | mid - Musical Instrument Digital Interface file |
| | | | | midi - Musical Instrument Digital Interface file |
| 6.019 | Lesson Builder | Create Lesson | Teacher clicks on the | a. The Create Exercise window is resized to a larger view, and the teacher |
| | | Window - | Multiple Choice radio | will also be allowed to view the Add or Remove choices section. |
| | | Evaluation | button. | |
| 6.020 | Lesson Builder | Create Lesson | Teacher writes a word or | a. The choice gets added to the list of available choices. |
| | | Window - | phrase in the New | b. The teacher is able to select the right answer(s) by using the check boxes |
| | | Evaluation | Choice text box and | located at the left side of each option. |
| | | | clicks the Add button. | |
| 6.021 | Lesson Builder | Create Lesson | Teacher clicks on the | a. The Create Exercise window is enlarged, and a two column grid appears. |
| | | Window - | Match radio button. | b. The teacher is able to enter matching values on a grid. |
| | | Evaluation | | |
| 6.021 | Lesson Builder | Create Lesson | Teacher clicks on the | a. The selected choice will be removed from the list. |
| | | Window - | Remove choice button. | |
| | | Evaluation | | |
| 6.022 | Lesson Builder | Create Lesson | Teacher clicks on the | a. If the exercise is Multiple Choice, an error message will be displayed if the |
| | | Window - | Add to lesson button. | Teacher has not selected the correct answer from the available choices. |
| | | Evaluation | | b. If the question text box has been left blank, a message will be displayed |
| | | | | indicating the teacher to provide the question. |
| | | | | c. If the exercise is a match and there are less than two matching values, an |
| | | | | error message appears. |
| | | | | d. The exercise is added to the list. |
| 6.023 | Lesson Builder | Create Lesson | Teacher clicks on the | a. The Create Exercise window is closed and all changes are ignored. |
| | | Window - | Cancel button. | |
| | | Evaluation | | |
| 6.024 | Lesson Builder | Create Lesson | Teacher clicks on the | a. A Create Exercise window will be displayed, containing the exercise to be |
| | | Window - | EDIT n exercise button. | modified. All other operations work the same as if creating a new exercise. |
| | | Evaluation | | b. If an exercise is not selected, a message will be displayed indicating the |
| | | | | teacher to select one. |
| 6.025 | Lesson Builder | Create Lesson | Teacher clicks on the | a. A small window containing an input text box will ask the teacher to provide |
| | | Window - | Add instructions button. | the instruction to be added. |
| | | Evaluation | | b. The teacher can choose to cancel and close the window. |
| 6.026 | Lesson Builder | Create Lesson | Teacher clicks on the | a. The selected exercises or instruction is removed from the list. |
| | | Window - | Delete Exercise button. | |
| | | Evaluation | | |
| 6.027 | Lesson Builder | Create Lesson | Teacher clicks on the | a. A browse folder dialog is displayed prompting the user to select a folder in |
| | | Window - | Browse button. | which the result of the evaluation is to be stored. |
| | | Evaluation | | b. Teacher must be able to make new folders. |
| 6.028 | Lesson Builder | Create Lesson | Teacher clicks on the | a. A File Save dialog is displayed to, allowing the user to type the name and |
| | | Window | Save button. | select the location of the file in which the lesson is to be saved. |
| | | | | b. A message will be shown if the lesson has no content or the exercise |
| | | | | result path has not been specified. |
| 6.029 | Lesson Builder | Create Lesson | Teacher clicks on the | a. Same functionality as the Save button, but allowing the teacher to save |
| | | Window | Save As button. | the file under a different name. |
| 6.030 | Lesson Builder | Create Lesson | Teacher clicks on the | a. The lesson is closed and all changes are lost if the Teacher hasn't saved |
| | | Window | Close button. | the lesson. |
| 7.002 | Lesson Builder | Evaluation | Teacher clicks on the | a. An Open file dialog is displayed. The teacher should be able to locate a |
| | | Manager | Evaluation menu and | file containing the *.eme extension. |
| | | | clicks Open. | b. Once a file is selected the evaluation window will display the following |
| | | | | data: |
| | | | | Student name |
| | | | | Evaluation date |
| | | | | Group |
| | | | | Score |
| | | | | A list of exercises contained within the evaluation. Multiple Choice |
| | | | | exercises are automatically corrected and marked as “Correct” or “Incorrect”. |
| | | | | Open Questions are marked as “-Review-”. |
| | | | | The first exercise in the evaluation |
| 7.003 | Lesson Builder | Evaluation | Teacher selects an | a. The selected exercise is displayed. |
| | | Manager | exercise from the list of | b. If the exercise is an Open Question, the teacher can use the drop down |
| | | | exercises. | labeled Exercise Result to classify the exercise as Correct or Incorrect, and |
| | | | | a numeric up-down text box to adjust the points according to the value of the |
| | | | | question. |
| | | | | c. If the exercise is Multiple Choice or Match, the Exercise Result drop down |
| | | | | and the Points numeric text box are disabled. |
| 7.004 | Lesson Builder | Evaluation | Teacher selects an | a. The value inside Points (numeric text box) is filled with the value of the |
| | | Manager | Open Question exercise | question. |
| | | | from the list (initially | b. The teacher is allowed to change and adjust that value. |
| | | | labeled as -Review-) and | |
| | | | selects Correct in the | |
| | | | Exercise Result drop | |
| | | | down list. | |
| 7.006 | Lesson Builder | Evaluation | Teacher clicks on the | a. A text box is displayed allowing the teacher to add notes to the current |
| | | Manager | View Comments button. | exercise. |
| | | | | b. Once the text box is displayed the caption of the button is changed from |
| | | | | View Comments to Hide Comments. A click on the Hide Comments button |
| | | | | will make the text box invisible. |
| 7.007 | Lesson Builder | Evaluation | Teacher makes changes | a. The Exercise Result and Points values are applied to the question. |
| | | Manager | to an exercise (results | b. The status of the question will change from -Review- to either Correct or |
| | | | and points) and clicks on | Incorrect. |
| | | | the Apply Changes | |
| | | | button. | |
| 7.008 | Lesson Builder | Evaluation | Teacher makes changes | a. Changes made to the current exercise will be applied automatically when |
| | | Manager | to an exercise (results | moving on to another exercise. |
| | | | and points) and selects | |
| | | | another exercise from | |
| | | | the exercise list without | |
| | | | first clicking the Apply | |
| | | | Changes button. | |
| 7.011 | Lesson Builder | Evaluation | Teacher clicks on the | a. A file save dialog is displayed allowing the teacher to choose the name |
| | | Manager | Evaluation menu and | and location of the HTML file. |
| | | | clicks Export to HTML. | b. Once the the teacher chooses a filename and clicks save the evaluation |
| | | | | will be exported to Hyper Text Markup Language (HTML) and will contain the |
| | | | | following: |
| | | | | The name of the student |
| | | | | Evaluation date |
| | | | | Group |
| | | | | A summary (horizontal table) containing all the questions and points |
| | | | | Total points |
| | | | | All incorrect exercises will contain an X, are displayed in red, and will |
| | | | | indicate the correct answers. |
| | | | | All correct exercises will be displayed in blue. |
| 7.012 | Lesson Builder | Evaluation | Teacher clicks on the | a. The evaluation will be printed. |
| | | Manager | Evaluation menu and | b. Information is displayed the same as exporting in HTML format. |
| | | | clicks Print. | |
| 8.001 | Student Desktop | Start Up | Student clicks on the | a. The EMNet Student Desktop splash window is displayed for a few |
| | | | EMNet Student Desktop | seconds showing the version number and copyright notice. |
| | | | shortcut. | b. An input window will ask the user to enter his or her name in the text box. |
| | | | | The student is not allowed to continue unless a name is provided. All invalid |
| | | | | name characters are filtered such as: |
| | | | | - ! @ # $ % \hat{ } & * ( ) _+ = − \| } { [ ] \ ″ : ; ? > < , . / |
| | | | | c. Once the name is provided the EMNet Student Desktop application |
| | | | | launches displaying a menu bar at the right-top of the screen. If the |
| | | | | application has been configured to connect to a specific teacher computer it |
| | | | | will connect to the teachers computer if the EMNet Classroom Manager |
| | | | | application is up and running. A green circle at the right end of the screen will |
| | | | | indicate a successful connection. |
| | | | | d. The Windows task bar and all the desktop icons become invisible. |
| | | | | e. All special Windows keys such as Win + R, Win + E, Win + F are disabled. |
| | | | | f. The Windows Task Manager becomes inaccessible. |
| 8.012 | Student Desktop | Network | User provides the name | a. A message box will indicate success. |
| | | Settings | (or IP) and the TCP port | b. Once the window is closed the application will try to connect the specified |
| | | | of the teacher's | IP address (or name of computer containing Classroom Manager) using the |
| | | | computer and clicks the | specified TCP port. |
| | | | OK button. | |

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A classroom network management system comprising:
a server computer running a manager program; and
a plurality of client computers each running a student desktop program and having controllable access to computerized resources,
wherein the server computer and the plurality of client computers are interconnected by a network, the manager program administering communications between the server computer and the client computers and communications among the client computers, and the manager program controlling access by the client computers to the computerized resources, and
wherein the manager program comprises a lesson builder tool that selectively stores lesson content for presentation on the client computers via the server computer, the lesson content including:
a lesson plan,
at least one file of a word processing application, spreadsheet application, presentation tools or multimedia,
exercises for student review, and
evaluations for student testing.

2. A classroom network management system according to claim 1, wherein the lesson builder tool enables access via the server computer to create, add, edit and delete lesson content.

3. A classroom network management system according to claim 1, wherein the lesson content comprises a lesson plan including fields as Title, Course, Author, Objectives, Strategy, Activities, Standard, and Evaluation.

4. A classroom network management system according to claim 1, wherein the lesson builder tool enables a selection of evaluation type via the server computer between multiple choice, true or false, matching, and open questions.

5. A classroom network management system according to claim 4, wherein the lesson builder tool enables entry of correct answers for evaluation types multiple choice, matching and true or false, and wherein the manager program monitors evaluation results via the server computer based on the correct answers.

6. A classroom network management system according to claim 1, wherein the network over which the server computer and the plurality of client computers are interconnected is a global network.

7. A classroom network management system comprising:
a plurality of student computers having controllable access to computerized resources; and
a manager system interconnected with the student computers via a network, the manager system administering communications between a teacher and the student computers and communications among the student computers, and the manager system controlling access by the student computers to the computerized resources,
wherein the manager system comprises:
a lesson module that stores lesson content for presentation on the student computers,
a screen sharing module that displays a screen view of the manager system to selected ones of the student computers, a screen view of selected ones of the student computers to the manager system, and a screen view of selected ones of the student computers to others of the student computers, and
a monitoring module that displays all of the student computer screen views to the manager system.

8. A classroom network management system according to claim 7, wherein the lesson module stores the lesson content including:
a lesson plan,
at least one file of a word processing application, spreadsheet application, presentation tools or multimedia,
exercises for student review, and
evaluations for student testing.

9. A classroom network management system according to claim 7, wherein the lesson module enables access via the manager system to create, add, edit and delete lesson content.

10. A classroom network management system according to claim 7, wherein the network over which the manager system is interconnected with the student computers is a global network.

11. A method of managing classroom activity, the method comprising:
running a manager program on a server computer; and
running a student desktop program on each of a plurality of client computers, the client computers having controllable access to computerized resources;
interconnecting the server computer and the plurality of client computers via a network;
the manager program administering communications between the server computer and the client computers and communications among the client computers;
the manager program controlling access by the client computers to the computerized resources; and
selectively creating and storing lesson plan content using a lesson builder tool for presentation on the client computers via the server computer, the lesson content including:
a lesson plan,
at least one file of a word processing application, spreadsheet application, presentation tools or multimedia,
exercises for student review, and
evaluations for student testing.

12. A method according to claim 11, wherein the network over which the server computer and the plurality of client computers are interconnected is a global network.
